(19) United States
(12) Patent Application Publication
(10) Pub. No.: US 2014/0373643 A1
(43) Pub. Date: Dec. 25, 2014

(54) INTERNALLY ILLUMINATED HEATING AND/OR CHILLING BATH

(71) Applicants: Dale D. Timm, JR., Solana Beach, CA (US); Anthony P. Cassiano, Solana Beach, CA (US); Michael A. Cassiano, Solana Beach, CA (US); Peter J. Defrancesca, Solana Beach, CA (US)

(72) Inventors: Dale D. Timm, JR., Solana Beach, CA (US); Anthony P. Cassiano, Solana Beach, CA (US); Michael A. Cassiano, Solana Beach, CA (US); Peter J. Defrancesca, Solana Beach, CA (US)

(21) Appl. No.: 13/926,486

(22) Filed: Jun. 25, 2013

(51) Int. Cl. G01N 1/44

(52) U.S. Cl. CPC G01N 1/44
USPC 73/863.11

(57) ABSTRACT

A heating and/or chilling bath with an internally illuminated specimen container receptacle for enhanced specimen examination or monitoring. Internal illumination provided either directly from light sources or redirected via light propagations rods. The enhanced illumination may include ultraviolet, visible light, infrared, and/or other electromagnetic ranges useful for illuminating specimens observation with the naked eye, microscopy, CCD, and/or other device assisted observation methods.

### FIELD OF THE PRESENT DISCLOSURE

This disclosure relates generally to scientific research equipment, and more particularly to heating and/or chilling baths featuring an internally illuminated specimen container receptacle for enhanced specimen examination and monitoring.

### BACKGROUND OF THE RELATED ART

Heating and chilling baths are a common variety of research equipment used in several fields of scientific research including molecular biology, microbiology, biochemistry, and genetics.

The purpose of a heating and/or cooling bath is to control the temperature of a specimen. Some applications may require one or more specimens to be cycled through a temperature profile while other applications may require specimens to be held at or near a particular critical temperature for an extended period of time to encourage a particular reaction, response, or development.

There are a variety of methods available to achieve temperature control. One such method of controlling the temperature of a specimen is to control the temperature of a fluid with a high specific heat, typically water, and circulate that fluid around the specimen containers thereby delivering or extracting heat energy to or from the specimen as desired. This method is referred to as a wet bath.

Another method of controlling the temperature of specimens is through the use of receptacles made of a thermally conductive material shaped to accept and support the specimen containers called blocks. Blocks are shaped to maximize surface contact with the specimen containers and are constructed from a material with high thermal conductivity so as to promote efficient and uniform thermal transfer. A block may be heated or chilled externally to deliver or extract heat energy to or from the specimens in a controlled and even manner. This method is typically called a dry bath.

When conducting scientific research using a heating and/or chilling bath, researchers are frequently attempting to ascertain an ideal by simultaneously comparing several specimens with similar, but not identical, characteristics. A researcher may then assay the performance of the various specimens to determine which attributes are associated with the most beneficial performance. This may include closely monitoring the reaction, response, or development of each specimen for small permutations using an unaided eye, microscopy, magnification, or other forms of assisted observation such as the use of a charge-couple device (CCD) sensors.

One challenge faced by researchers is adequately illuminating specimens for observation. Many specimen containers have very small cross-sectional diameters which limit exposure to ambient light, especially specimen containers shaped to fit into blocks designed to accommodate assays with large sample numbers. Ambient light is further restricted by the opaque materials, such as aluminum, from which blocks are typically constructed. Additionally, when attempting to observe specimens using microscopy, CCD, or other device-assisted observation techniques, there may be a need for light augmentation beyond ambient magnitude levels or light augmentation in specific wave lengths or ranges of wavelengths designed to fluoresce or better distinguish specimens or specific specimen characteristics. There exists a need for a heating and/or chilling bath with enhanced specimen illumination capabilities to address these challenges.

Alternatively, a researcher may manually remove each specimen container from the block and expose the sample to a source of the desired variety of light for examination or observation. However, this procedure may be both time consuming and, in some applications, could risk disturbing the specimen the researcher aims to examine or observe. There exists a need for a non-evasive enhanced illumination of specimens such that specimen removal prior to examination or observation is not required.

The present disclosure distinguishes over the related art providing heretofore unknown advantages as described in the following summary.

### BRIEF SUMMARY OF THE INVENTION

The present disclosure relates to an apparatus for running temperature-controlled assays while increasing observation capability through enhanced specimen illumination. The apparatus includes a receptacle for holding a plurality of specimen containers and a means of delivering or extracting heat energy to control the temperature of such specimens while enhancing the illumination of the specimens.

In an exemplary embodiment the specimen holding receptacle may be constructed from a material with a high thermal conductivity such as aluminum or a similar metal. Receptacles of this variety are often called blocks. Blocks feature substantially vertical cavities or wells sized and shaped such that specimen containers may be inserted. A typical block may accommodate a plurality of such specimen containers. Blocks may then be heated or chilled externally and are capable of efficiently delivering or extracting heat energy to or from the specimen containers in a uniform manner, thereby changing or maintaining the temperature of the specimens within the specimen containers.

The presently disclosed apparatus features a means of illuminating such specimens from below or within the cavities or wells. In an exemplary embodiment, light is provided through an opening or aperture in the cavity or well. The apertures may be positioned either at the most internal distal end of the cavities or wells or at a more medial location. If the specimen container is transparent or translucent, light may propagate through the specimen container and illuminate the specimen. This provides a critical advantage for research and experimentation involving specimens that must be examined or observed closely.

The light source may emit the full range of visible light as well as wavelengths outside the visible range such as infrared or ultraviolet or it may be limited to specific ranges specially designed to fluoresce or distinguish a specimen or a characteristic within a specimen. The choice of light may be tailored to the specimen and the desired observation technique, whether it be with the naked eye, microscopy, CCD, or other suitable sensor or device-assisted method such as spectrophotometry. In some embodiments the light source may be several independent light sources, such as light emitting diodes (“LEDs”), capable of emitting electromagnetic radiation in various wave length ranges that may be used in conjunction or separately depending on the needs of the research or experimentation.

In some embodiments, the light source may be located directly adjacent to the cavity or well allowing the light source to directly illuminate the intended cavity or well. Such embodiments may feature light sources located internal to the block or external to the block in a direct propagation line to the cavity or well.

In other embodiments, the light source may not be in a direct propagation line to the cavity or well. In such embodiments the light may be redirected from the light source. This may be accomplished through the use of at least one light propagating rod that is capable of redirecting and propagating light.

A light propagating rod may be a length of silica, plastic, or other material with similar properties that is capable of propagating and distributing light from one terminal end to the other. Depending on the particular material from which the light propagation rod is composed, the physical shape and attributes of the light propagation rod, and the direction and wavelength of the propagating light, light may propagate the length of the light propagating rod and exit the opposing terminal end or it may exit the light propagating rod axially or substantially axially before reaching the opposing terminal end. The preferred light exit mechanism and location may be determined by the particular design of the embodiment.

For example, in some embodiments, the light propagation rod may be oriented such that its terminal end is directly aligned with the cavity or well that is designed to be illuminated, while in other embodiments, the light propagation rod may pass tangentially to the desired cavity or well and rely on radially-exiting light for illumination.

When or where radially-exiting light is not desired, reflective cladding may be applied to all or a portion of the external surface of the light propagating rod to prevent such light from exiting. Reflective cladding may redirect light back into the light propagating rod preserving the intensity of the light exiting the light propagating rod at desired locations.

The light propagation rods may vary in length and diameter considerably depending on the embodiment design. In the exemplary illustrated embodiment, the light propagation rods are linear and cylindrical. In other embodiments, light propagation rods may be shaped otherwise to direct the propagating light and increase the intensity of the light that reaches desired locations. For example, some embodiments may include flat, thin, and/or curved light propagation rods or light propagating rods that that may resemble optical fibers.

This disclosure teaches certain benefits in construction and use which give rise to the objectives described below.

A primary objective is to provide a heating and/or chilling bath featuring an internally illuminated specimen container receptacle to enhance illumination for visual examination or monitoring of specimens.

Another objective is to provide a heating and/or chilling bath featuring an internally illuminated specimen container receptacle to enhance illumination for the use of microscopy, CCD, or other specimen examination or monitoring technologies.

A further objective is to provide a heating and/or chilling bath featuring the ability to internally illuminate specimens with specific light wavelengths or ranges of wavelengths.

A still further objective is to provide a heating and/or chilling bath featuring an internally illuminated specimen container receptacle to increase assay analysis efficiency.

A yet still further objective is to provide a heating and/or chilling bath featuring an internally illuminated specimen container receptacle to enable specimen observation or monitoring without specimen container removal or disruption.

Other features and advantages of the present invention will become apparent from the following more detailed description, taken in conjunction with the accompanying drawings, which illustrate, by way of example, the principles of the presently described apparatus.

### BRIEF DESCRIPTION OF THE DRAWING(S)

The accompanying drawings are diagrams that illustrate various exemplary implementations and are part of the specification. The illustrated implementations are proffered for purposes of example, not for purposes of limitation. Illustrated elements and steps will be designated by numbers. Once designated, an element or step will be identified by the identical number throughout. Illustrated in the accompanying diagram drawings is at least one of the best mode embodiments of the present disclosure. In such drawings:

FIG. 1 is a perspective view of an exemplary embodiment of the presently disclosed apparatus;

FIG. 2 is an exploded perspective view of an exemplary embodiment of an internally illuminated block featuring light propagation rods each coupled with a single light source;

FIG. 3 is an exploded perspective view of an exemplary embodiment of an internally illuminated block featuring light propagation rods each coupled with dual opposing light sources;

FIG. 4 is an assembled perspective view of an exemplary embodiment of an internally illuminated block;

FIG. 5 is a cross-sectional perspective view of an exemplary embodiment of an internally illuminated block;

FIG. 6 is an assembled perspective view of an exemplary embodiment of an internally illuminated block featuring dual opposing light sources;

FIG. 7 is a cross-sectional perspective view of an exemplary embodiment of an internally illuminated block featuring dual opposing light sources;

FIG. 8 is a perspective view of an exemplary embodiment of a tapered light propagation rod;

FIG. 9 is a plan view of an exemplary embodiment of a tapered light propagation rod;

FIG. 10 is a perspective view of an exemplary embodiment of a dual tapered light propagation rod;

FIG. 11 is a plan view of an exemplary embodiment of a dual tapered light propagation rod;

FIG. 12 is a perspective view of an exemplary embodiment of a light propagation rod featuring light directing indentures;

FIG. 13 is a plan view of an exemplary embodiment of a light propagation rod featuring light directing indentures;

FIG. 14 is a perspective view of an exemplary embodiment of a light propagation rod with a flat terminus;

FIG. 15 is a perspective view of an exemplary embodiment of a light propagation rod with a concave terminus;

FIG. 16 is a perspective view of an exemplary embodiment of a light propagation rod with a convex terminus.

### DETAILED DESCRIPTION OF THE EXEMPLARY EMBODIMENT

The above described drawings illustrate an exemplary embodiment of an apparatus in at least one of its preferred, best mode embodiments, which is further defined in detail in the following description. Those having ordinary skill in the art may be able to make alterations and modifications to what is described herein without departing from the spirit and scope of the disclosure. Therefore, it must be understood that what is illustrated is set forth only for the purposes of example, and that it should not be taken as a limitation of the scope of the present apparatus.

Described now in detail is a heating and/or chilling bath with a specimen container receptacle featuring internal illumination.

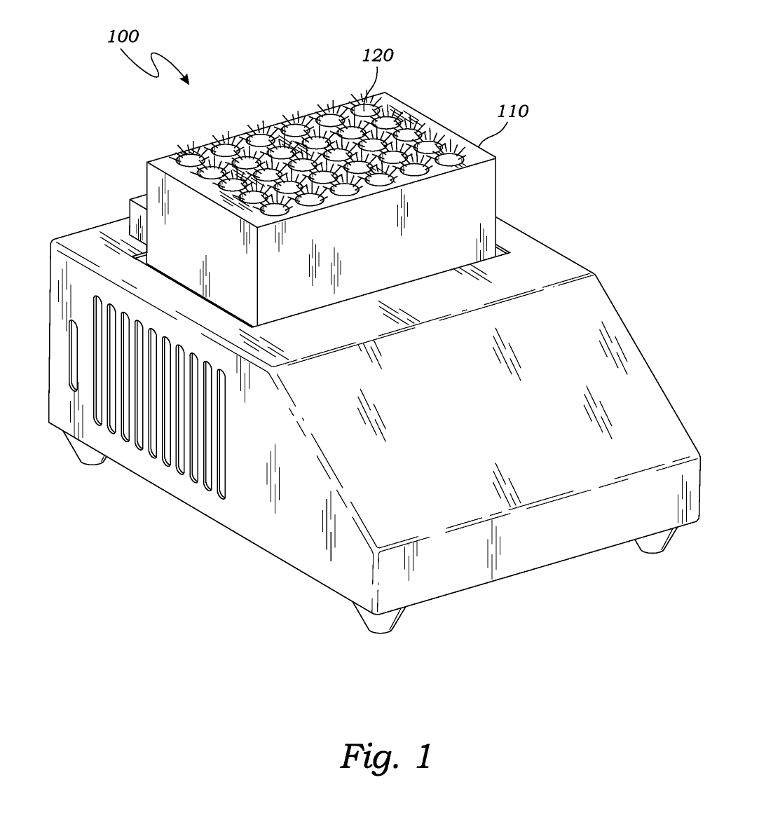

FIG. 1 is an illustration of an exemplary heating and/or chilling dry bath 100 with a specimen container receptacle called a block 110 capable of internal illumination. The exemplary block 110 features a plurality of substantially vertical cavities or wells 120 sized to accommodate specimen containers such as test tubes, centrifuge tubes, assay plates, vials, or similar specimen containers.

The internally illuminated block 110 depicted in FIG. 1 is situated on a heat transfer mechanism capable of externally delivering and extracting heat energy to or from the block 110 as needed to achieve or maintain a desired specimen temperature or temperature profile. The block 110 is capable of distributing heat energy quickly and evenly maintaining a consistent temperature throughout, as it is constructed from a material with high thermal conductivity. Blocks are typically constructed from metals such as aluminum, but any thermally-conductive material will suffice.

The exemplary embodiment in FIG. 1 illustrates a heat transfer mechanism that uses Peltier technology to deliver and/or extract heat energy from the block. Heat transfer mechanisms utilizing other technologies may be used as well, such as refrigerants and compressors, circulation of preheated or cooled fluids, other standard heating technologies such as electrical heating elements and/or combustion, and/or cooling through the controlled expansion of compressed gaseous elements or compounds.

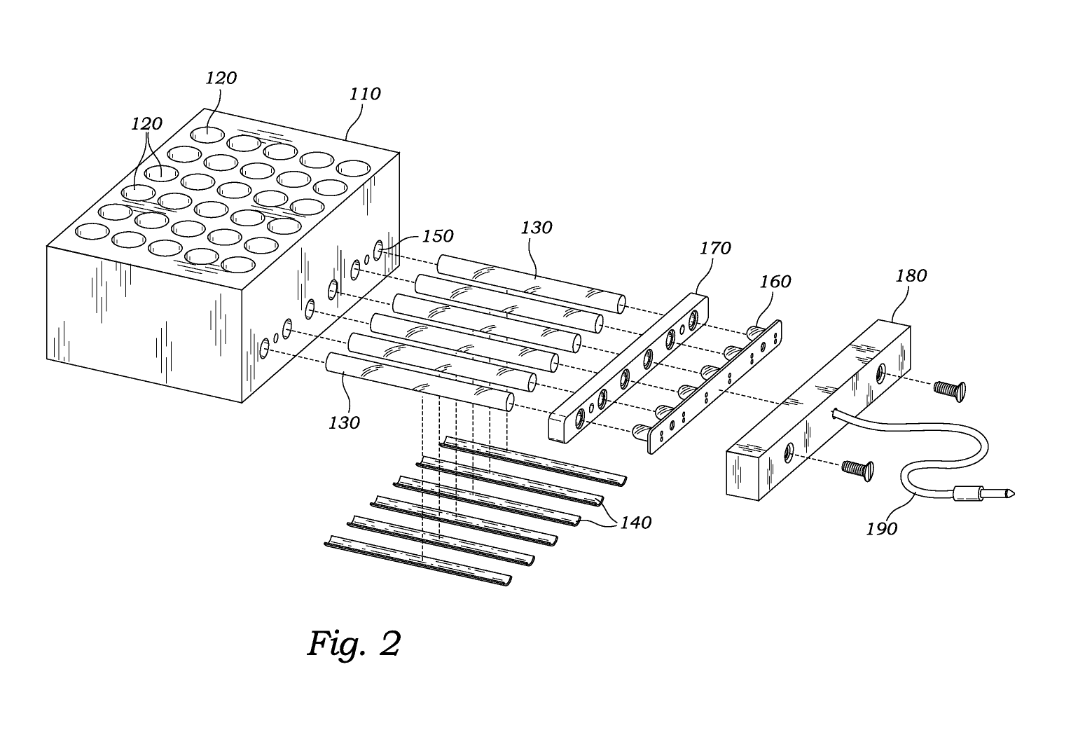

FIG. 2 illustrates an exploded view of an exemplary embodiment of the presently disclosed apparatus 100 that features a plurality of substantially horizontal cavities 150 sized to accommodate light propagating rods 130. The light propagating rods 130 are inserted into the substantially horizontal chambers 150 and may propagate light from light sources 160 located outside the block 110 to cavities or wells 120 within the block 110. In other embodiments, the light sources 160 may be located inside the block 110 as well.

FIG. 2 also illustrates reflective cladding 140 located along the inferior surface of each light propagating rod 130 and a light source 160 located at its terminal end. The reflective cladding 140 may be physically separate and placed adjacent the light propagating rod 130 or it may be a dispersion within or a coating applied to or adhered to the external surface of the light propagating rod 130. In some embodiments, the reflective cladding 140 is designed to redirect light exiting the light propagating rod 130 in undesirable places back into the light propagating rod 130 so that more light will be available to exit the light propagating rod 130 at the desired exit locations. In other embodiments, the reflective cladding 140 is utilized to direct the light out at the desired exit location(s) of the light propagating rod 130. In different embodiments of the presently disclosed apparatus, reflective cladding 140 may cover more or less of the surface of the light propagating rod 130 as needed to achieve desired results.

FIG. 2 also depicts exemplary hardware 170 designed to align the light source 160 with the terminal end of each light propagating rod 130, a cover 180 to protect the light source 160, and an electrical cord 190 to provide power for the light source 160. These features are meant to be an illustration of an exemplary embodiment and are not intended to be limiting.

The light source 160 shown in FIG. 2 is comprised of a plurality of LEDs. LEDs are a particularly good light sources 160 because they are small and provide high intensity light for relatively low power consumption. Conventional light bulbs may be used as light sources 160 as well. The present disclosure is not limited to light sources 160 that produce visible light. When appropriate for the researchers, light sources 160 that produce electromagnetic radiation in the infrared, ultraviolet, or other wave lengths may be used as well.

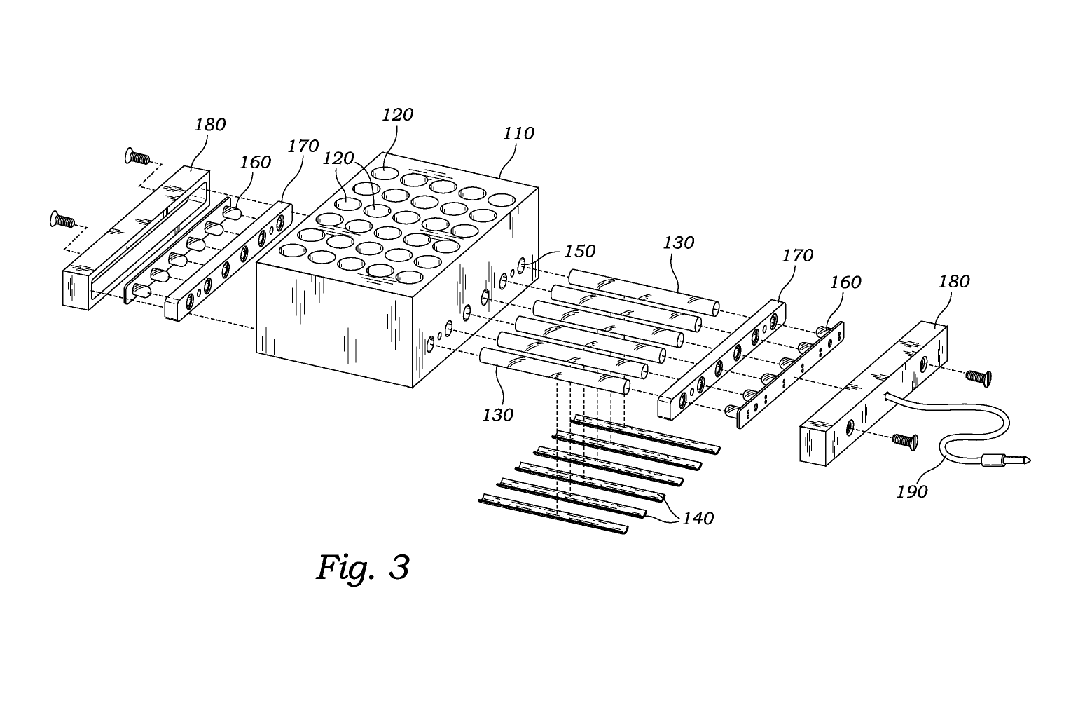

FIG. 3 is very similar to FIG. 2 except that FIG. 3 depicts an embodiment of the presently disclosed apparatus that includes a second set of light sources 160 located at the opposing terminal end of each light propagating rod 130. The second set of light sources 160 may increase the intensity of the light propagating through the light propagation rods 130 and ultimately the intensity of light that may illuminate the intended specimen. The present disclosure may have light sources 160 in any location that assists the illumination of the specimen containers. Some embodiments may have a light sources 160 located directly adjacent each cavity or well 150 thereby eliminating the necessity of the light propagating rod 130. Additionally, some embodiments may have multiple types of light source devices in the same location to provide options for the frequency of light desired to illuminate the specimen containers (e.g.: UV, color, UV, and/or other useful electromagnetic frequency ranges).

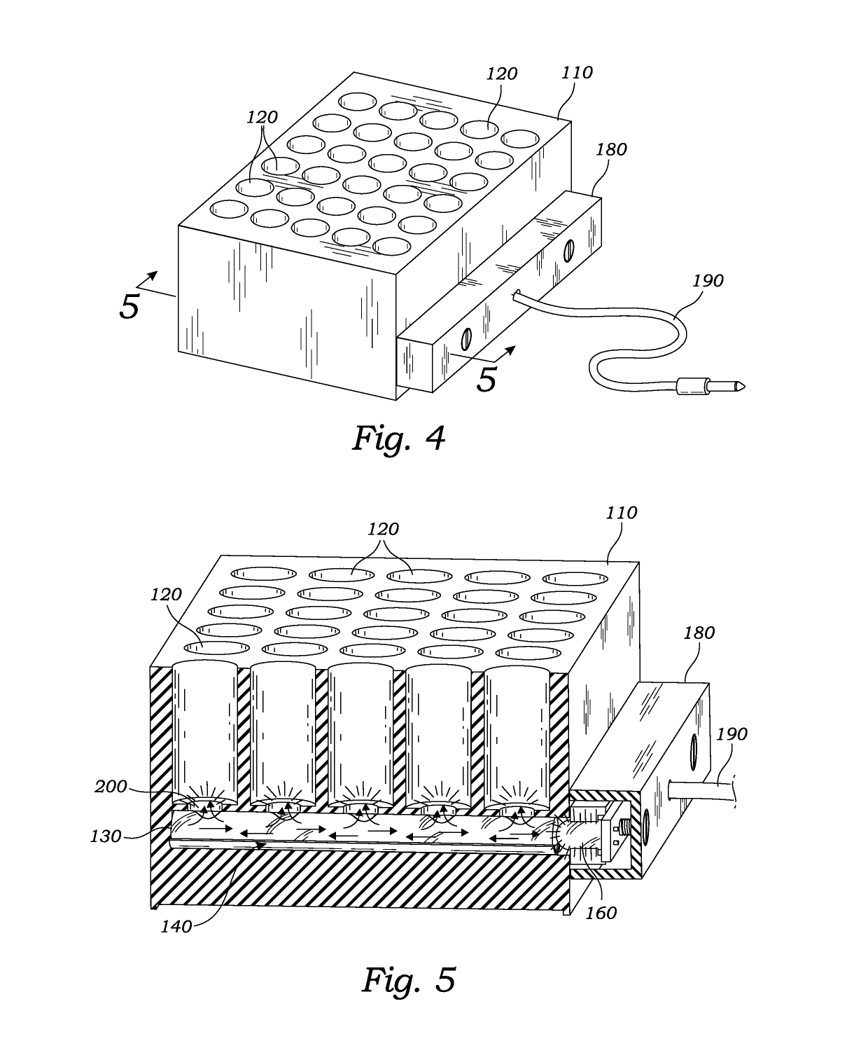

FIG. 4 illustrates an assembled internally illuminated block 110 and FIG. 5 illustrates a cross-section of that block 110. The cross-section illustration shows a light propagating rod 130 positioned beneath, and perpendicular to, a plurality of substantially vertical cavities or wells 120 and an aperture 200 located at the most internal distal end of each substantially vertical cavity or well 120 that allows light exiting radially from the superior surface of the light propagating rod 130 to reach the cavities or wells 120. Light exiting radially from the inferior surface is reflected back into the light propagating rod 130 by the reflective cladding 140 located adjacent the inferior surface of the light propagating rod 130. Light that reaches the terminal end of the light propagating rod 130 may be reflected back into the light propagating rod 130. The configuration illustrated in FIG. 5 is not the only configuration that can achieve the purpose of this disclosed apparatus. In other embodiments the apertures 200 may be positioned medially along each substantially vertical cavity or well 120, so long as light may pass through the apertures 200 and illuminate the substantially vertical cavities or wells 120.

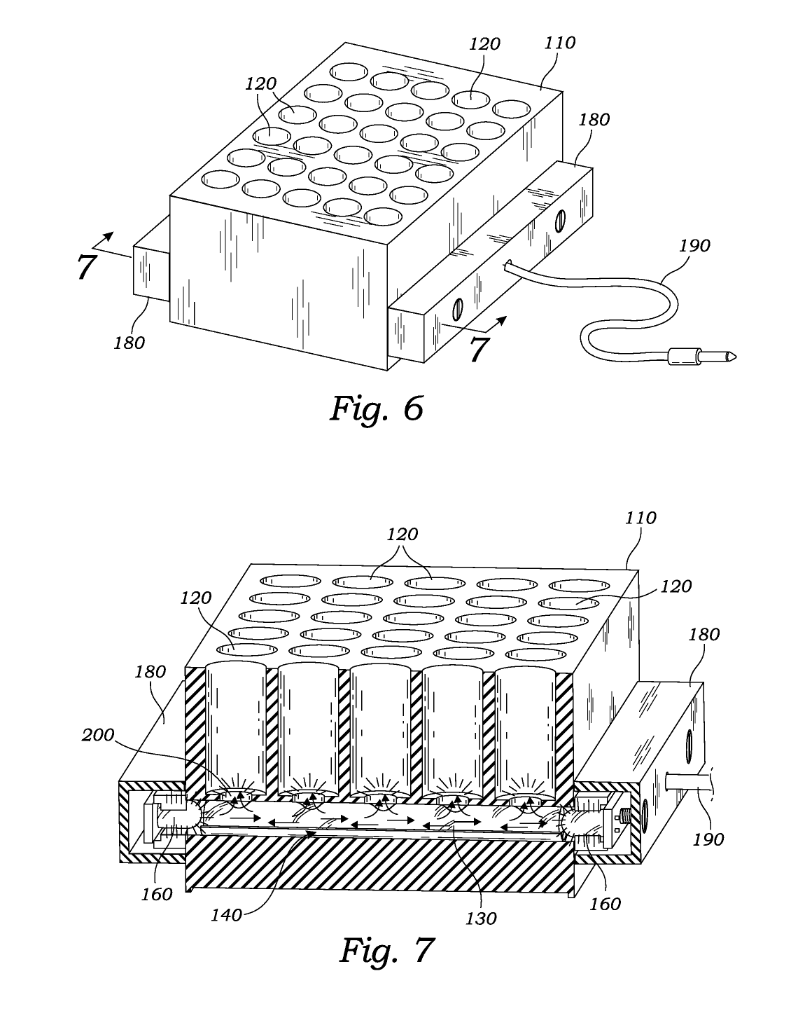

FIGS. 5 and 6 illustrate an embodiment with dual light sources. The dual light sources may serve to increase the light intensity or, in some embodiments, each light source may emit a light of different variety or wavelength of light thereby providing illumination across a broader spectrum. The dual light source may be used simultaneously or independently as desired.

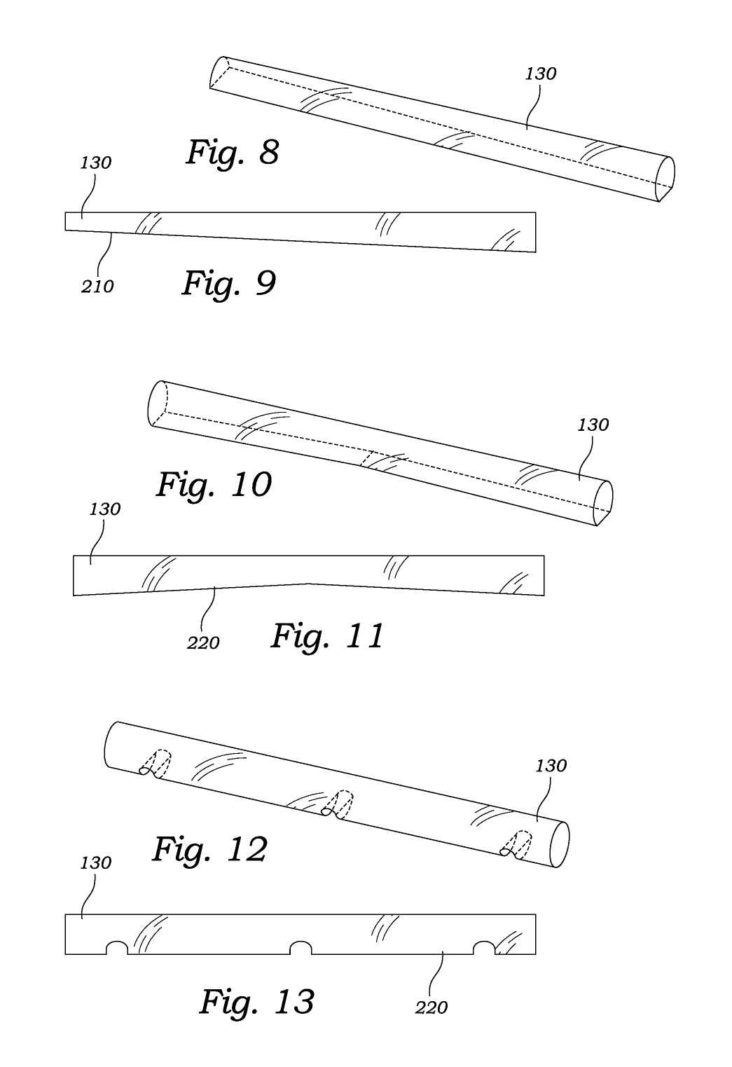

In some embodiments the light propagation rods 130 are not perfectly cylindrical as depicted in FIGS. 2 and 3. For example, FIGS. 8 and 9 illustrate a light propagation rod 130 with a flat and inclined inferior surface 210. The inclined inferior surface 210 may be coated with or lined with reflective cladding 140 to direct more light to the superior surface of the light propagation rod 130. Light propagating axially down the light propagating rod 130 may, at some point, collide with the inclined inferior surface 210 of the light propagating rod 103 depicted in FIGS. 8 and 9 and be redirected toward the superior surface of the light propagating rod 130.

FIGS. 10 and 11 illustrate an exemplary embodiment of a light propagation rod 130 that features a dual inclined inferior surface 220 with an incline initiating from each terminal end converging at a medial point for use with dual opposing light sources 160. Still other embodiments such as FIGS. 12 and 13 may include indentures 220 or other obstructions designed to redirect propagating light to a desired location. These features may be coupled with reflective cladding 140 to enhance the desired effect.

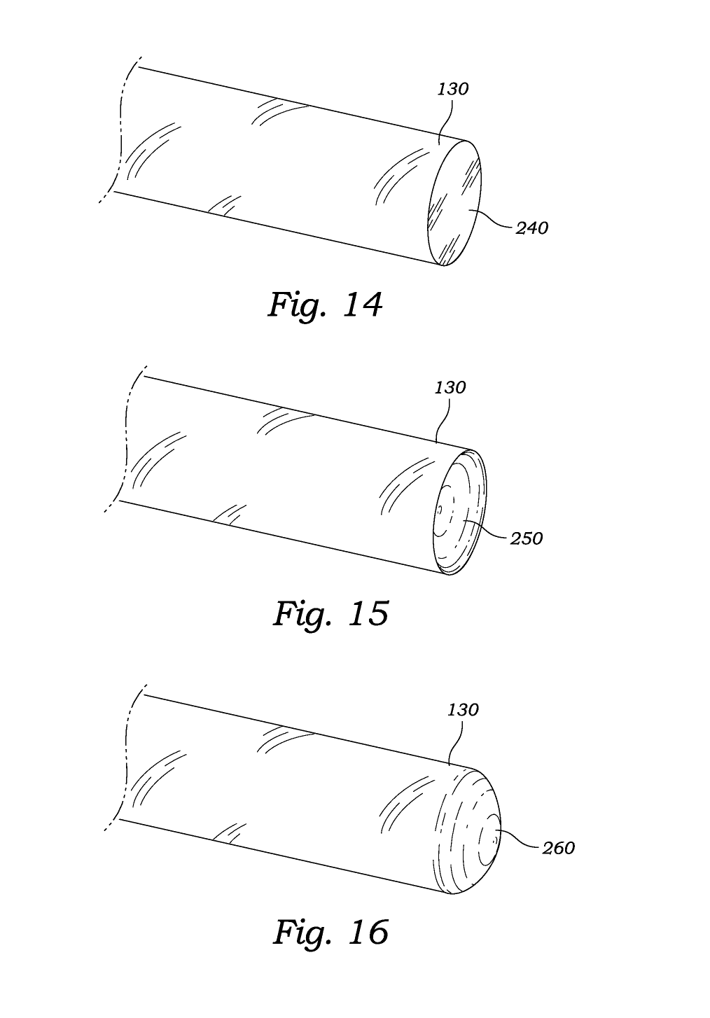

Other features of the light propagating rods 130 designed to redirect light in a desired direction is the shape of the terminal end of the light propagating rod 130. A flat terminal end 240 as illustrated in FIG. 14. can receive and propagate light as transmitted. However, it is best suited for receiving light travelling in a direction substantially parallel to the axis of the light propagating rod 130. Other light propagating rod 130 terminal end configurations may be used to receive incoming light and/or initially redirect it as desired such as the concave terminal end 250 which is featured in FIG. 15 or the convex terminal end 260 which is featured in FIG. 16. The particular degree of concavity or convexity may be adjusted to achieve the desired performance.

The enablements described in detail above are considered novel over the prior art of record and are considered to be critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventors believe that the claimed subject matter is what is intended to be patented.

What is claimed is:

1. An apparatus for illuminating sample specimens while maintaining temperature control for examination and monitoring, said apparatus comprising:
a block of thermally conductive material capable of accepting or rejecting heat energy and distributing it in a uniform manner with a plurality of wells shaped to accommodate and support specimen containers each featuring at least one aperture through which light may pass; and
at least one light source oriented to internally illuminate said plurality of wells.

2. An apparatus of claim 1 where said light source is at least one LED located directly adjacent and capable of illuminating each of said plurality of wells.

3. An apparatus of claim 1 wherein said light source is capable of emitting electromagnetic radiation in multiple different wavelength ranges.

4. An apparatus of claim 1 further comprising a means of influencing the heat energy of said block.

5. An apparatus of claim 1 further comprising:
at least one light propagating rod in luminary communication with said light source and said apertures, wherein light emanating from said light source may be redirected by and propagate through said light propagating rod to said plurality of wells via said apertures thereby illuminating said plurality of wells.

6. An apparatus as of claim 5 further comprising:
reflecting cladding on said light propagation rod to redirect light within said light propagation rod toward specific desired locations.

7. An apparatus of claim 4 wherein said means of externally influencing the heat energy of said block involves Peltier technology.

8. An apparatus for illuminating sample specimens while maintaining temperature control for examination and monitoring, said apparatus comprising:
a block with a plurality of wells shaped to accommodate and support specimen containers;
at least one light source oriented to internally illuminate said plurality of wells; and
a heat energy control mechanism for delivering and extracting heat energy to and from said block.

9. An apparatus of claim 8 further comprising:
at least one light propagating rod in luminary communication with said light source and said plurality of wells, such that light emanating from said light source may be redirected by and propagate through said light propagating rod to said plurality of wells thereby illuminating said plurality of wells.

10. An apparatus as of claim 9 further comprising:
reflecting cladding on the external surface of said light propagation rod to redirect light within said light propagation rod toward specific desired locations.

11. An apparatus for illuminating sample specimens while maintaining temperature control for examination and monitoring, said apparatus comprising:
a block of thermally conductive material featuring a plurality of substantially vertical cavities shaped to accommodate specimen containers having a first and second terminal end wherein said first terminal end is open to the superior surface of said block and said second terminal end features an aperture through which light may pass; and
at least one light source positioned to illuminate said substantially vertical cavities via said apertures.

12. The apparatus of claim 11 further comprising:
at least one substantially horizontal cavity in said block, positioned inferior to said second terminal end of said plurality of substantially vertical cavities such that said apertures allow light to pass between said substantially horizontal cavity and said plurality of substantial vertical cavities;
at least one light propagating rod positioned internal to said substantially horizontal cavity of similar length, wherein at least one said light source is positioned adjacent to at least one terminal end of said light propagating rod such that light from said light source may be redirected by and propagate through said light propagating rod and illuminate said plurality of substantially vertical cavities via said apertures.

13. The apparatus in claim 12 further comprising:
reflecting cladding on the external surface of said light propagation rod to redirect light within said light propagation rod toward specific desired locations.

14. The apparatus in claim 13 wherein said light source is at least one LED capable of emitting electromagnetic radiation in multiple different wavelengths.

15. The apparatus in claim 14 wherein the inferior surface of the said light propagating rod is inclined away from said light source altering the angle of incidence between the propagating light and the inferior surface of said light propagation rod thereby increasing the quantity of light directed toward the superior surface of said light propagating rod.

16. The apparatus in claim 14 wherein the inferior surface of at least one light propagating rod is inclined away from both terminal ends altering the angle of incidence between the propagating light and the inferior surface of said light propagation rod thereby increasing the quantity of light directed toward the superior surface of said light propagating rod.

17. The apparatus in claim 14 wherein the inferior surface of the said light propagating rod features a plurality of curved indentures vertically aligned with said apertures altering the angle of incidence between the propagating light and the inferior surface of said light propagation rod and redirecting a portion of the propagating light toward the superior surface of said light propagating rod.

18. The apparatus in claim 14 wherein said light propagating rod is substantially cylindrical with flat terminal ends perpendicular to the axis of said light propagating rod.

19. The apparatus in claim 14 wherein said light propagating rod is substantially cylindrical with concave terminal ends perpendicular to the axis of said light propagating rod.

20. The apparatus in claim 14 wherein said light propagating rod is substantially cylindrical with convex terminal ends perpendicular to the axis of said light propagating rod.
